(19) United States
(12) Patent Application Publication
(10) Pub. No.: US 2013/0117069 A1
(43) Pub. Date: May 9, 2013

(54) SYSTEM TO POPULATE SALES PLAN

(71) Applicants: Dirk Wagner, Schiffweiler (DE); Jan Matthes, Darmstadt (DE); Martin Steiert, Heidelberg (DE)

(72) Inventors: Dirk Wagner, Schiffweiler (DE); Jan Matthes, Darmstadt (DE); Martin Steiert, Heidelberg (DE)

(21) Appl. No.: 13/289,153

(22) Filed: Nov. 4, 2011

(51) Int. Cl. G06Q 30/02

(52) U.S. Cl. 705/7.31

(57) ABSTRACT

A system may include determination, for each of a first plurality of time periods, of a first plurality of values of a first sales metric, where each of the first plurality of values is associated with a respective one of a plurality of sales categories, determination, for each of a second plurality of time periods, of a second plurality of values of a second sales metric, where each of the second plurality of values is associated with a respective one of the plurality of sales categories, determination, for each of a third plurality of time periods, of an expected sales value for each of the plurality of sales categories, determination, for each one of the third plurality of time periods, of a total expected sales value based on the expected sales values, and display of a visualization of the expected sales values.

### FIELD

Some embodiments relate to the creation of reports based on business data. More specifically, some embodiments relate to systems to create a sales plan.

### BACKGROUND

A sales plan is a well-known tool for defining sales targets for one or more sales categories. A sales category may be defined by any combination of geographical region, corporate entity, product, or other characteristic. For example, a sales plan may define sales targets for automobile tires in the U.S. Northeast. A sales plan may specify sales targets for one or more time periods, such as a single sales target for a sales category for a particular year, and/or a sales target for a sales category for each month of a particular year.

Typically, a sales plan for an upcoming year (e.g., 2011) is generated during the last quarter of the current year (e.g., 2010). The sales plan may take into account, for example, incoming sales orders in the current year as a guideline for what to expect in the upcoming year. However, little incoming sales order data may exist for the time period between generation of the plan and the end of the current year. The user must therefore identify and gather other data for generating sales targets for the remainder of the year.

This problem is exacerbated as the number of sales categories in a sales plan increases. That is, a user must identify and gather data for generating sales targets for each of the multiple sales categories during the remainder of the year. Although such a process may provide a sales plan reflecting a total sales target across all sales categories, the process does not operate in reverse, i.e., it does not provide the generation of sales targets for several time periods and several sales categories based on an initially-provided total sales target.

Systems are therefore needed to efficiently generate a sales plan. Moreover, systems are desired for efficiently defining sales targets within such a sales plan for various sales categories and in view of a desired sales total.

### BRIEF DESCRIPTION OF THE DRAWINGS

FIG. 1 is a block diagram of a system according to some embodiments.

FIG. 2 is a flow diagram of a process according to some embodiments.

FIG. 3 is a view of a spreadsheet application user interface according to some embodiments.

FIG. 4 is a view of a spreadsheet application user interface according to some embodiments.

FIG. 5 is a view of a spreadsheet application user interface according to some embodiments.

FIG. 6 is a view of a spreadsheet application user interface according to some embodiments.

FIG. 7 is a view of a spreadsheet application user interface according to some embodiments.

FIG. 8 is a view of a spreadsheet application user interface according to some embodiments.

FIG. 9 is a view of a spreadsheet application user interface according to some embodiments.

FIG. 10 is a view of a spreadsheet application user interface according to some embodiments.

FIG. 11 is a block diagram of a computing device according to some embodiments.

### DETAILED DESCRIPTION

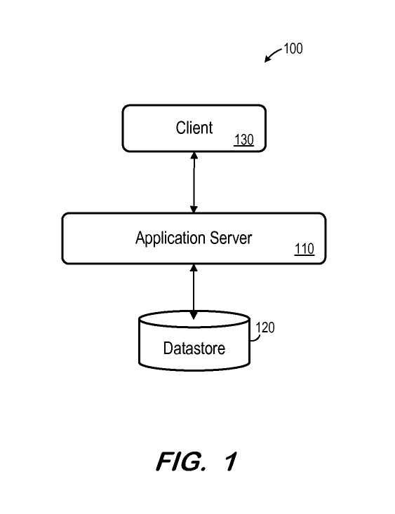

FIG. 1 is a block diagram of system 100 according to some embodiments. FIG. 1 represents a logical architecture for describing processes according to some embodiments, and actual implementations may include more or different components arranged in other manners.

System 100 includes application server 110 to provide data of datastore 120 to client 130. For example, client 130 may send a request for sales figures to application server 110 and, in response, application server 110 delegates the request to datastore 120, retrieves the requested figures from datastore 120 and returns them to client 130.

Datastore 120 may comprise any one or more systems to store business data. The data stored in datastore 120 may be received from disparate hardware and software systems, some of which are not interoperational with one another. The systems may comprise a back-end data environment employed in a business or industrial context. The data may be pushed to datastore 120 and/or provided in response to queries received therefrom.

The data of datastore 120 may be stored in a traditional fixed disks or in-memory (e.g., in Random Access Memory) to allow fast retrieval and processing thereof. The data may comprise a relational database, an in-memory database, a multi-dimensional database, an eXtendable Markup Language (XML) document, and/or any other structured data storage system. The physical tables of datastore 120 may be distributed among several relational databases, dimensional databases, and/or other data sources. To provide economies of scale, datastore 120 may include data of more than one customer. Application server 110 therefore includes mechanisms to ensure that a client accesses only the data that the client is authorized to access. Moreover, the data of datastore 120 may be indexed and/or selectively replicated in an index.

Client 130 displays user interfaces and data received from application server 110, and may also be operated to process such data and send data back to application server 110 for storage in datastore 120. Client 130 may comprise any suitable device, such as a desktop computer, a laptop computer, a personal digital assistant, a tablet PC, and a smartphone. Client 130 may execute program code of a rich client application, an applet in a Web browser, or any other application to perform the processes attributed thereto herein. According to some embodiments, client 130 executes a standalone application (e.g., a spreadsheet application) which communicates with application server 110 via Web Services to retrieve data therefrom.

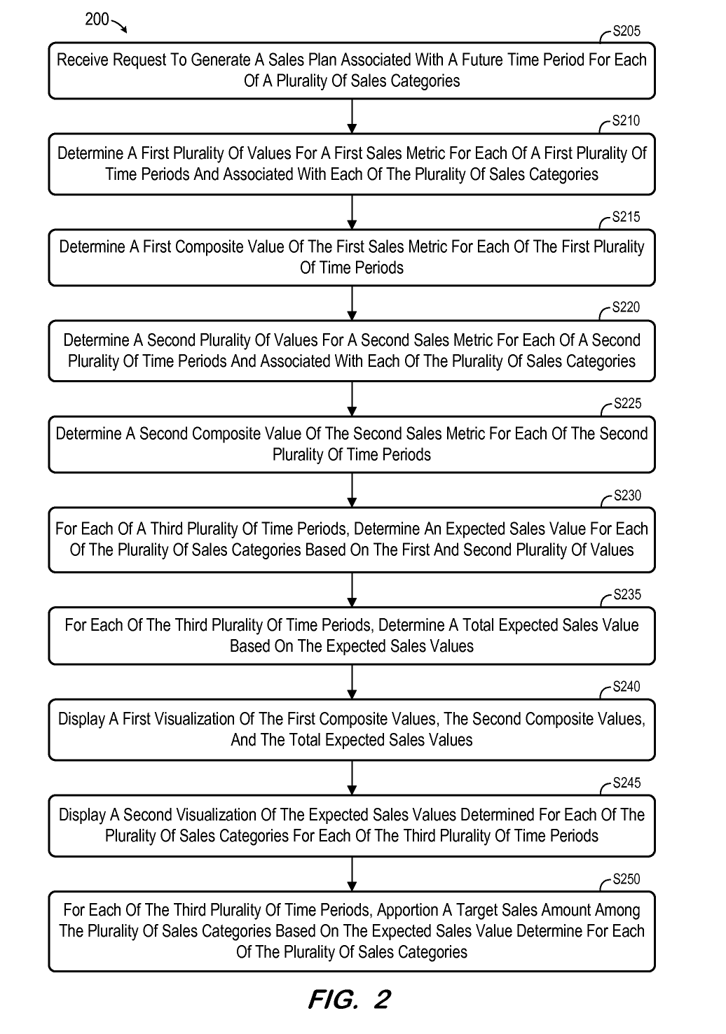

FIG. 2 comprises flow diagram of process 200 according to some embodiments. In some embodiments, various hardware elements of system 100 execute program code to perform process 200. In some embodiments, hard-wired circuitry may be used in place of, or in combination with, program code for implementation of processes according to some embodiments. Embodiments are therefore not limited to any specific combination of hardware and software.

Initially, at S205, a request is received to generate a sales plan associated with a future time period for each of a plurality of sales categories. To assist in the present description of an example of process 200, FIG. 2 shows a view of user interface 300 according to some embodiments. User interface 300 may be presented on a display of client 130 in response to execution of a spreadsheet application by a processor of client 130. Alternatively, user interface 300 may be a Web page displayed by a Web browser application executed by the processor. Embodiments are not limited to these examples.

According to the present example, it will be assumed that the Head of Finance at Akron Heating Inc. has already created the illustrated plan (i.e., Plan 2011) and specified the Sales Budget of 7.5M USD. Next, the Head of Sales has selected Sales Unit Plan from pull-down menu 310 to view the plan. Forecast 2010 tab 320 is then selected to request generation of the sales plan at S205.

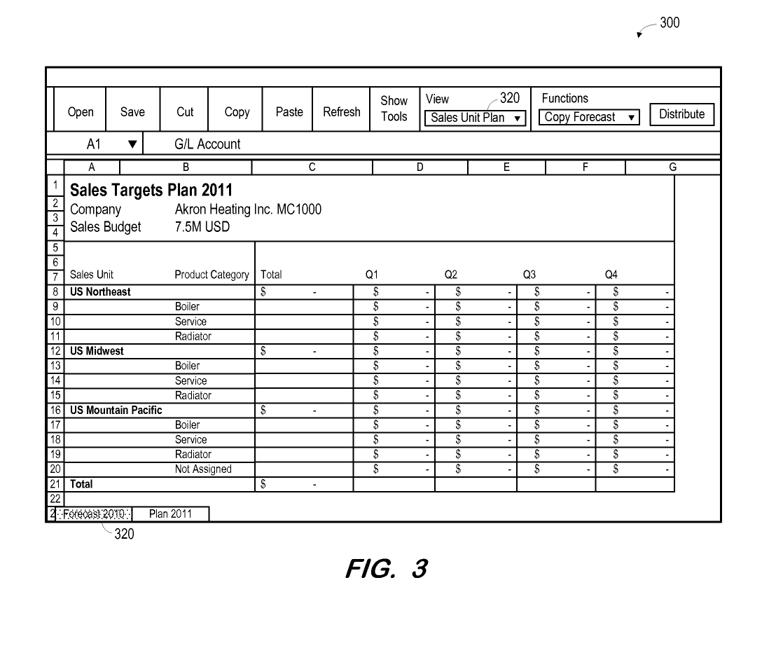

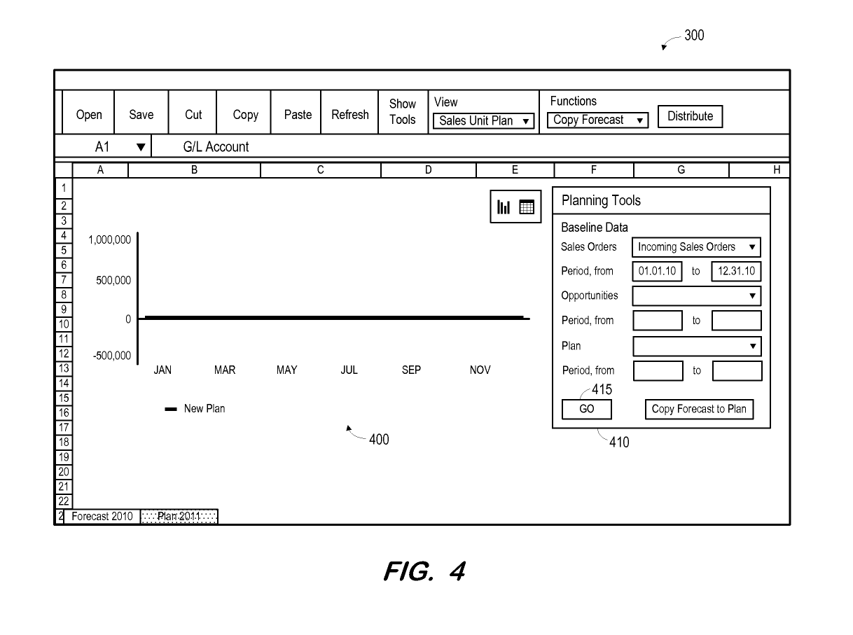

In response to the request, user interface 300 displays visualization 400 of FIG. 4. Visualization 400 is intended to allow the user to operate at the macro (i.e., total) level in order to generate the sales plan (i.e., Plan 2011) for each of the sales categories shown in FIG. 3.

User interface 300 of FIG. 4 also includes Planning Tools control 410. Planning Tools control 410 allows the user to select sales metrics used to generate the sales plan, and a time period associated with each sales metric. As will be described below, the time periods associated with the selected sales metrics may fully, partially or not overlap.

As shown in FIG. 4, the user has selected Incoming Sales Orders as a first sales metric, and has specified the corresponding period 1.01.10 to 12.31.10. Since visualization 400 is a monthly chart, the specified period may be understood as specifying twelve separate time periods (JAN 2010, FEB 2010, . . . , DEC 2010) for which the sales metric will be evaluated. Other sales metrics that may be used in some embodiments include, but are not limited to, Sales Contracts, Customer Contracts, and Credit Memos.

The user then selects GO control 415. Then, at S210, and for each of the plurality of time periods, a first plurality of values of the first sales metric is determined, where each of the first plurality of values is associated with a respective one of the plurality of sales categories. For example, S210 may comprise determining, for each sales category shown in FIG. 3, incoming sales orders for each month of 2010. Next, at S215, a composite value is determined for each one of the plurality of time periods based on the first plurality of values determined for the one of the plurality of time periods. In the present example, the incoming sales orders determined for a particular month for all sales categories are summed at S215.

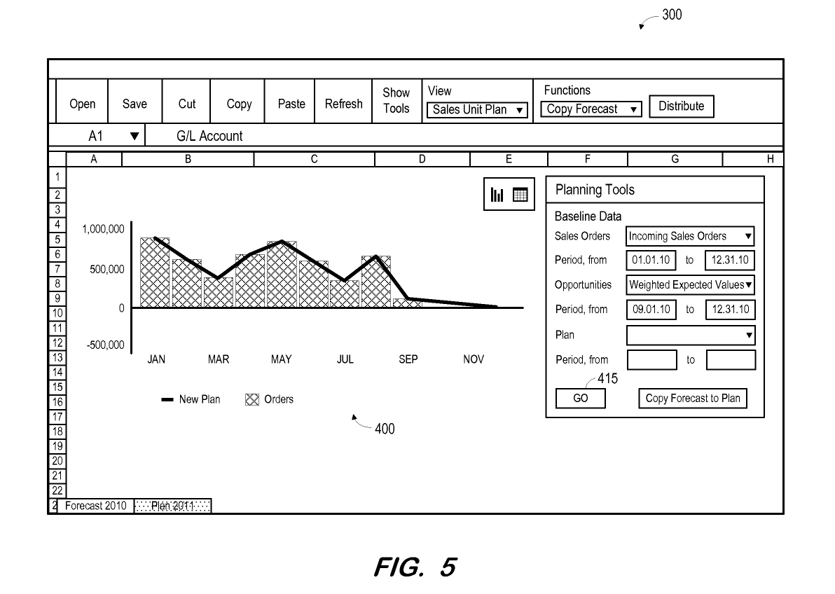

FIG. 5 illustrates visualization 400 showing the composite value determined at S215 for each of the plurality of time periods. Notably, the composite values for October, November and December are zero because no sales orders or opportunities are associated with those time periods (e.g., because those time periods are in the future). Therefore, and as also shown in FIG. 5, the user has selected Weighted Expected Values of Opportunities as a second sales metric, and has specified the corresponding period 9.01.10 to 12.31.10.

Again, the user then selects GO control 415 and, at S220, and for each of the plurality of time periods (i.e., SEPT 2010, OCT 2010, NOV 2010, DEC 2010), a second plurality of values of the second sales metric is determined, where each of the second plurality of values is associated with a respective one of the plurality of sales categories. In the present example, S220 comprises determining, for each sales category, the weighted expected values of opportunities for each of the last four months of 2010. Next, a composite value is determined at S225 for each one of the plurality of time periods based on the second plurality of values determined for the plurality of time periods. The composite value is the sum of all weighted expected values of opportunities determined for a particular month for all sales categories.

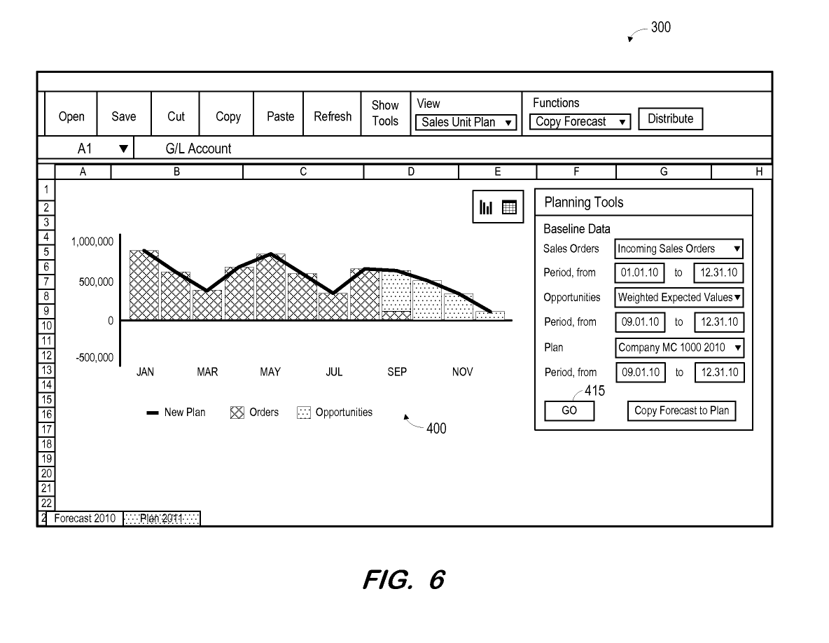

FIG. 6 illustrates visualization 400 showing the composite value determined at S225 for each of the plurality of time periods. Since the sum of all weighted expected values of opportunities in December is zero, the user has selected Company MC 1000 2010 Plan as a third sales metric, and has specified the corresponding period 9.01.10 to 12.31.10. This third metric reflects the plan which was previously generated for the current year.

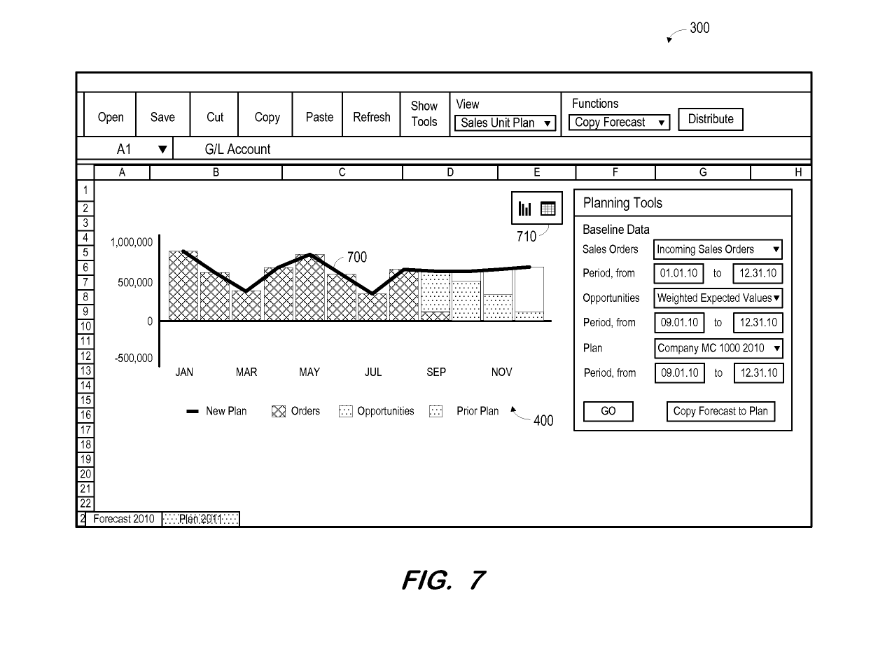

After selection of GO control 415, a third plurality of values of the third sales metric is determined for each of the plurality of time periods and for each of the plurality of sales categories. The third plurality of values simply consists of the monthly sales targets for each of the sales categories for each of the last four months of 2010. These values are summed according to month and the results are displayed in visualization 400 of FIG. 7.

Next, at S230, an expected sales value for each of the plurality of sales categories is determined for each of a third plurality of time periods. The expected sales value is determined based on the determined first plurality of values and the determined second plurality of values. The present example also includes a third plurality of values (i.e., the monthly sales targets for each of the sales categories), therefore the determination of the expected sales values in this example will also be based on the third plurality of values.

In one example of S230, the values determined for a particular sales category for a particular month will be used to determine an expected sales value for that sales category in that particular month. For January 2010 through August 2010, the expected sales value is simply equal to the incoming sales order value for that sales category in the particular month. However, for September 2010 through December 2010, the expected sales value is equal to the greater of the weighted expected values of opportunities and the 2010 sales target in the particular month. This calculation is repeated for every sales category. Embodiments are not limited to this particular calculation.

At S235, a total expected sales value for each one of the third plurality of time periods is determined based on the determined expected sales values. In the present example, the total expected sales value for a given month is the sum of the expected sales values determined for that month. Next, at S240, a first visualization is displayed, including the first composite value determined for each one of the first plurality of time periods, the second composite value determined for each one of the second plurality of time periods, and the total expected sales value determined for each one of the third plurality of time periods.

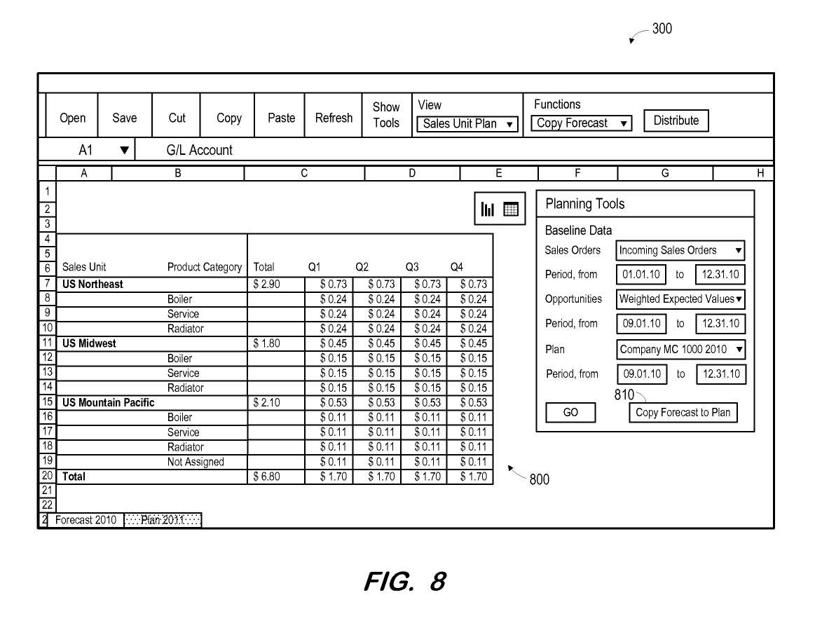

Visualization 400 of FIG. 7 is an example of a visualization displayed at S240. Visualization 400 shows the composite value determined for the Incoming Sales Orders sales metric for each month, the composite value determined for the Weighted Expected Values of Opportunities sales metric for each month, and the composite value determined for the 2010 Plan sales metric for each month. New Plan line 700 identifies the total expected sales value determined for each month at S235. The user then selects table icon 710 to invoke the view of FIG. 8.

Table 800 of FIG. 8 is a visualization of the expected sales values determined for each of the plurality of sales categories for each of the time periods. Accordingly, although interface 300 of FIGS. 4 through 7 allowed the user to work with and evaluate overall totals, these totals were computed based on individual sales category values, which are reflected in the expected sales values of table 800. The user then selects Copy Forecast to Plan control 810.

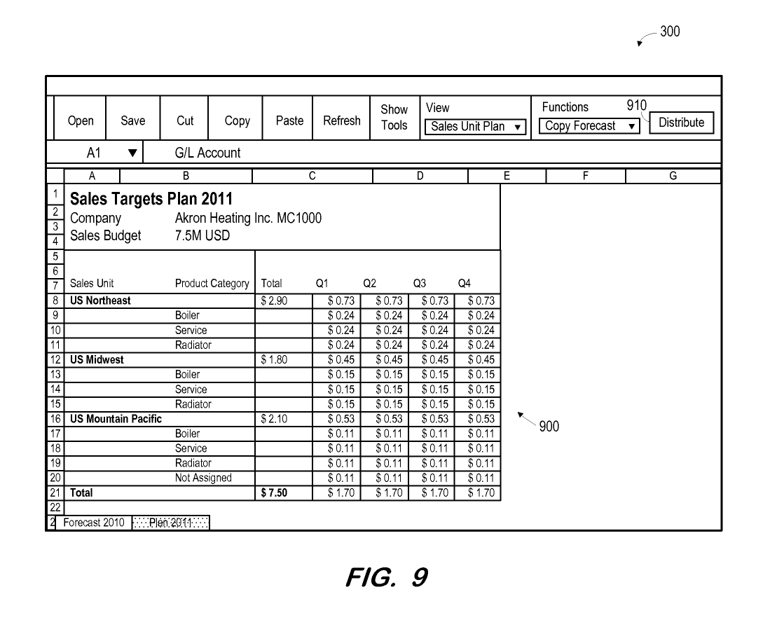

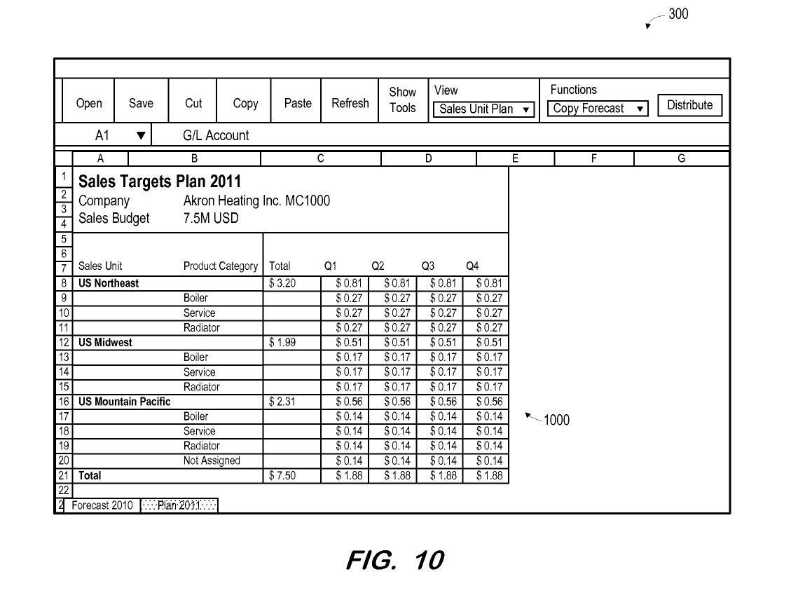

FIG. 9 shows resulting user interface 300 as shown in FIG. 3, albeit with table 900 populated with values of table 800. Additionally, the user has changed the overall Total from $6.80 to $7.50 to reflect the Sales Budget of 7.5M USD. Next, the user selects Distribute control 910. In response, the target sales amount is apportioned among the plurality of sales categories based on the expected sales value determined for each of the plurality of sales categories. The apportioned amounts are shown in table 1000 of FIG. 10. Therefore, table 1000 illustrates a 2011 sales plan for each of the plurality of sales categories and for each of a plurality of time periods, and which is consistent with an overall target sales amount of 7.5M USD.

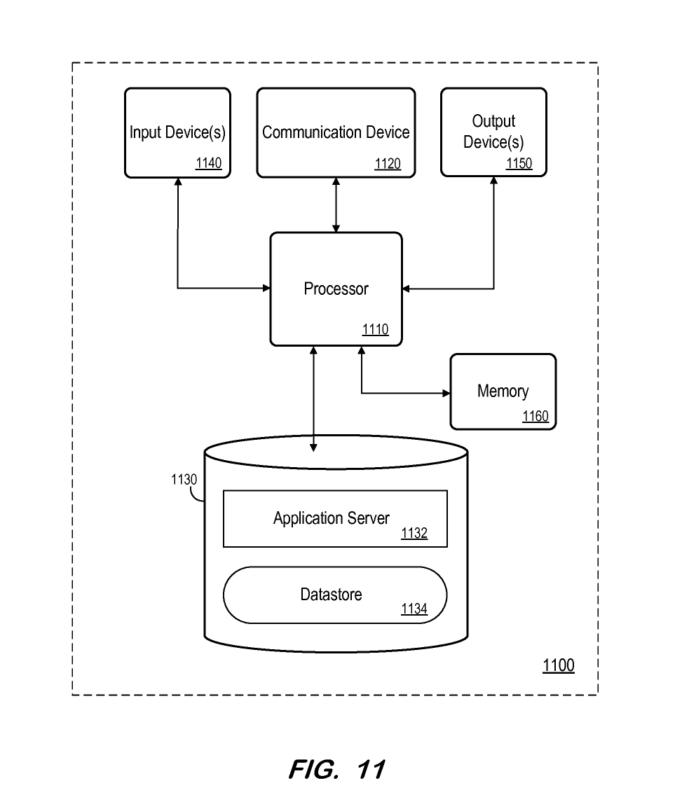

FIG. 11 is a block diagram of apparatus 1100 according to some embodiments. Apparatus 1100 may comprise a general-purpose computing apparatus and may execute program code to perform any of the functions described herein. Apparatus 1100 may comprise an implementation of one or more elements of system 100, and/or of a client device on which the user interfaces and diagrams of the present description are presented. Apparatus 1100 may include other unshown elements according to some embodiments.

Apparatus 1100 includes processor 1110 operatively coupled to communication device 1120, data storage device 1130, one or more input devices 1140, one or more output devices 1150 and memory 1160. Communication device 1120 may facilitate communication with external devices, such as an external design tool. Input device(s) 1140 may comprise, for example, a keyboard, a keypad, a mouse or other pointing device, a microphone, knob or a switch, an infra-red (IR) port, a docking station, and/or a touch screen. Input device(s) 1140 may be used, for example, to enter information into apparatus 1100. Output device(s) 1150 may comprise, for example, a display (e.g., a display screen) a speaker, and/or a printer.

Data storage device 1130 may comprise any appropriate persistent storage device, including combinations of magnetic storage devices (e.g., magnetic tape, hard disk drives and flash memory), optical storage devices, Read Only Memory (ROM) devices, etc., while memory 1160 may comprise Random Access Memory (RAM).

Application server 1132 of data storage device 1130 may comprise program code executable by processor 1110 to provide any of the functions described herein. Embodiments are not limited to execution of these functions by a single apparatus. Datastore 1134 may include data as described herein with respect to datastore 120. As also mentioned herein, memory 1160 may also or alternatively store data of data store 120, with datastore 1134 providing a persistent backup. Data storage device 1130 may also store data and other program code for providing additional functionality and/or which are necessary for operation thereof, such as device drivers, operating system files, etc.

Other topologies may be used in conjunction with other embodiments. Moreover, each system described herein may be implemented by any number of computing devices in communication with one another via any number of other public and/or private networks. Two or more of such computing devices of may be located remote from one another and may communicate with one another via any known manner of network(s) and/or a dedicated connection. Each computing device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more computer-readable non-transitory media. Such media non-transitory media may include, for example, a fixed disk a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

The embodiments described herein are solely for the purpose of illustration. Those in the art will recognize other embodiments may be practiced with modifications and alterations limited only by the claims.

What is claimed is:

1. A method implemented by a computing system in response to execution of program code by a processor of the computing system, the method comprising:
for each of a first plurality of time periods, determining a first plurality of values of a first sales metric, where each of the first plurality of values of the first sales metric determined for one of the first plurality of time periods is associated with a respective one of a plurality of sales categories;
for each one of the first plurality of time periods, determining a first composite value of the first sales metric based on the first plurality of values determined for the one of the first plurality of time periods;
for each of a second plurality of time periods, determining a second plurality of values of a second sales metric, where each of the second plurality of values of the second sales metric determined for one of the second plurality of time periods is associated with a respective one of the plurality of sales categories;
for each one of the second plurality of time periods, determining a second composite value of the second sales metric based on the second plurality of values determined for the one of the second plurality of time periods;
for each of a third plurality of time periods, determining an expected sales value for each of the plurality of sales categories based on the determined first plurality of values and the determined second plurality of values;
for each one of the third plurality of time periods, determining a total expected sales value based on the expected sales values determined for the one of the third plurality of time periods;
displaying a first visualization of the first composite value determined for each one of the first plurality of time periods, of the second composite value determined for each one of the second plurality of time periods, and of the total expected sales value determined for each one of the third plurality of time periods; and
displaying a second visualization of the expected sales values determined for each of the plurality of sales categories for each of the third plurality of time periods.

2. A method according to claim 1, further comprising:
receiving a target sales amount; and
for each one of the third plurality of time periods, apportioning the target sales amount among the plurality of sales categories based on the expected sales value determined for each of the plurality of sales categories for the one of the third plurality of time periods.

3. A method according to claim 1, wherein at least one of the first plurality of time periods is identical to at least one of the second plurality of time periods, and
wherein determination of the expected sales value for each of the plurality of sales categories for each of the identical time periods comprises summing respective ones of the determined first plurality of values and the determined second plurality of values.

4. A method according to claim 3, wherein the first sales metric comprises incoming sales order value and the second sales metric comprises expected opportunity value.

5. A method according to claim 1, further comprising:
for each of a fourth plurality of time periods, determining a fourth plurality of values of a third sales metric, where each of the fourth plurality of values of the third sales metric determined for one of the fourth plurality of time periods is associated with a respective one of the plurality of sales categories; and
for each one of the fourth plurality of time periods, determining a third composite value of the third sales metric based on the fourth plurality of values determined for the one of the fourth plurality of time periods;
wherein the determination of the expected sales value for each of the plurality of sales categories for each of a third plurality of time periods is based on the determined first plurality of values, the determined second plurality of values and the determined third plurality of values, and
wherein the first visualization comprises the third composite value determined for each one of the fourth plurality of time periods.

6. A method according to claim 5, wherein at least one of the second plurality of time periods is identical to at least one of the third plurality of time periods, and
wherein determination of the expected sales value for each of the plurality of sales categories for each of the identical time periods comprises selecting the greater of respective ones of the determined second plurality of values and the determined third plurality of values and summing the selected values with respective ones of the determined first plurality of values.

7. A method according to claim 6, wherein the first sales metric comprises incoming sales order value, the second sales metric comprises expected opportunity value, and the third sales metric comprises historical sales plan value.

8. A non-transitory medium storing processor-executable program code, the program code executable by a device to:
determine, for each of a first plurality of time periods, a first plurality of values of a first sales metric, where each of the first plurality of values of the first sales metric determined for one of the first plurality of time periods is associated with a respective one of a plurality of sales categories;
determine, for each one of the first plurality of time periods, a first composite value of the first sales metric based on the first plurality of values determined for the one of the first plurality of time periods;
determine, for each of a second plurality of time periods, a second plurality of values of a second sales metric, where each of the second plurality of values of the second sales metric determined for one of the second plurality of time periods is associated with a respective one of the plurality of sales categories;
determine, for each one of the second plurality of time periods, a second composite value of the second sales metric based on the second plurality of values determined for the one of the second plurality of time periods;
determine, for each of a third plurality of time periods, an expected sales value for each of the plurality of sales categories based on the determined first plurality of values and the determined second plurality of values;
determine, for each one of the third plurality of time periods, a total expected sales value based on the expected sales values determined for the one of the third plurality of time periods;
display a first visualization of the first composite value determined for each one of the first plurality of time periods, of the second composite value determined for each one of the second plurality of time periods, and of the total expected sales value determined for each one of the third plurality of time periods; and
display a second visualization of the expected sales values determined for each of the plurality of sales categories for each of the third plurality of time periods.

9. A medium according to claim 8, the program code further executable by a device to:
receive a target sales amount; and
for each one of the third plurality of time periods, apportion the target sales amount among the plurality of sales categories based on the expected sales value determined for each of the plurality of sales categories for the one of the third plurality of time periods.

10. A medium according to claim 8, wherein at least one of the first plurality of time periods is identical to at least one of the second plurality of time periods, and
wherein determination of the expected sales value for each of the plurality of sales categories for each of the identical time periods comprises summing respective ones of the determined first plurality of values and the determined second plurality of values.

11. A medium according to claim 10, wherein the first sales metric comprises incoming sales order value and the second sales metric comprises expected opportunity value.

12. A medium according to claim 8, the program code further executable by a device to:
determine, for each of a fourth plurality of time periods, a fourth plurality of values of a third sales metric, where each of the fourth plurality of values of the third sales metric determined for one of the fourth plurality of time periods is associated with a respective one of the plurality of sales categories; and
determine, for each one of the fourth plurality of time periods, a third composite value of the third sales metric based on the fourth plurality of values determined for the one of the fourth plurality of time periods;
wherein the determination of the expected sales value for each of the plurality of sales categories for each of a third plurality of time periods is based on the determined first plurality of values, the determined second plurality of values and the determined third plurality of values, and
wherein the first visualization comprises the third composite value determined for each one of the fourth plurality of time periods.

13. A medium according to claim 12, wherein at least one of the second plurality of time periods is identical to at least one of the third plurality of time periods, and
wherein determination of the expected sales value for each of the plurality of sales categories for each of the identical time periods comprises selecting the greater of respective ones of the determined second plurality of values and the determined third plurality of values and summing the selected values with respective ones of the determined first plurality of values.

14. A medium according to claim 13, wherein the first sales metric comprises incoming sales order value, the second sales metric comprises expected opportunity value, and the third sales metric comprises historical sales plan value.

15. A system comprising:
a computing device comprising:
a memory system storing processor-executable program code; and
a processor to execute the processor-executable program code in order to cause the computing device to:
determine, for each of a first plurality of time periods, a first plurality of values of a first sales metric, where each of the first plurality of values of the first sales metric determined for one of the first plurality of time periods is associated with a respective one of a plurality of sales categories;
determine, for each one of the first plurality of time periods, a first composite value of the first sales metric based on the first plurality of values determined for the one of the first plurality of time periods;
determine, for each of a second plurality of time periods, a second plurality of values of a second sales metric, where each of the second plurality of values of the second sales metric determined for one of the second plurality of time periods is associated with a respective one of the plurality of sales categories;
determine, for each one of the second plurality of time periods, a second composite value of the second sales metric based on the second plurality of values determined for the one of the second plurality of time periods;
determine, for each of a third plurality of time periods, an expected sales value for each of the plurality of sales categories based on the determined first plurality of values and the determined second plurality of values;
determine, for each one of the third plurality of time periods, a total expected sales value based on the expected sales values determined for the one of the third plurality of time periods;
display a first visualization of the first composite value determined for each one of the first plurality of time periods, of the second composite value determined for each one of the second plurality of time periods, and of the total expected sales value determined for each one of the third plurality of time periods; and
display a second visualization of the expected sales values determined for each of the plurality of sales categories for each of the third plurality of time periods.

16. A medium according to claim 15, the processor to further execute the processor-executable program code in order to cause the computing device to:
receive a target sales amount; and
for each one of the third plurality of time periods, apportion the target sales amount among the plurality of sales categories based on the expected sales value determined for each of the plurality of sales categories for the one of the third plurality of time periods.

17. A medium according to claim 15, wherein at least one of the first plurality of time periods is identical to at least one of the second plurality of time periods, and
wherein determination of the expected sales value for each of the plurality of sales categories for each of the identical time periods comprises summing respective ones of the determined first plurality of values and the determined second plurality of values.

18. A medium according to claim 17, wherein the first sales metric comprises incoming sales order value and the second sales metric comprises expected opportunity value.

19. A medium according to claim 15, the processor to further execute the processor-executable program code in order to cause the computing device to:
determine, for each of a fourth plurality of time periods, a fourth plurality of values of a third sales metric, where each of the fourth plurality of values of the third sales metric determined for one of the fourth plurality of time periods is associated with a respective one of the plurality of sales categories; and
determine, for each one of the fourth plurality of time periods, a third composite value of the third sales metric based on the fourth plurality of values determined for the one of the fourth plurality of time periods;
wherein the determination of the expected sales value for each of the plurality of sales categories for each of a third plurality of time periods is based on the determined first plurality of values, the determined second plurality of values and the determined third plurality of values, and
wherein the first visualization comprises the third composite value determined for each one of the fourth plurality of time periods.

20. A medium according to claim 19, wherein at least one of the second plurality of time periods is identical to at least one of the third plurality of time periods, and
wherein determination of the expected sales value for each of the plurality of sales categories for each of the identical time periods comprises selecting the greater of respective ones of the determined second plurality of values and the determined third plurality of values and summing the selected values with respective ones of the determined first plurality of values.

21. A medium according to claim 20, wherein the first sales metric comprises incoming sales order value, the second sales metric comprises expected opportunity value, and the third sales metric comprises historical sales plan value.
